(19) United States
(12) Patent Application Publication
(10) Pub. No.: US 2024/0361981 A1
(43) Pub. Date: Oct. 31, 2024

(54) Voice-based user interface system, method and device

(71) Applicant: SANDEEP KUMAR R, ANDRA PRADESH (IN)

(72) Inventor: SANDEEP KUMAR R, ANDRA PRADESH (IN)

(73) Assignee: SANDEEP KUMAR R, ANDRA PRADESH (IN)

(21) Appl. No.: 18/687,913

(22) PCT Filed: Aug. 31, 2022
(86) PCT No.: PCT/IB2022/058174

§ 371 Date: Feb. 29, 2024

(30) Foreign Application Priority Data
Sep. 1, 2021 (IN) 202141039534

(51) Int. Cl. G06F 3/16; G06F 3/0482; G06F 3/0484; G06F 9/451; G10L 15/18; G10L 15/22

(52) U.S. Cl. CPC G06F 3/167; G06F 3/0482; G06F 3/0484; G06F 9/451; G10L 15/18; G10L 15/22; G10L 2015/223

(57) ABSTRACT

Exemplary embodiments of the present disclosure are directed to a voice-based user interface system 10 comprising a voice assembly 12 for processing voice-inputs into voice commands comprising cluster commands and a computing device comprising a focus zone 22 defined within a display thereof. When a cluster 30, which comprises one or more user-selectable items, is within the focus zone 22 whereby said cluster 30 and thereby each of the one or more selectable items thereof are said to be focused, the reception of a cluster command by the computing device results in a corresponding focused item being selected.

### TECHNICAL FIELD

The present invention relates to a novel voice-based system and method for interfacing with computing devices such as smartphones, tablets, and the like. The invention also relates to the computing device itself that is incorporated with novel voice-based user interface elements pertaining to the aforementioned system and method.

### BACKGROUND

The granular reach of virtual voice assistants (viz., Google Assistant, Siri, Bixby, Alexa, etc.) on smart devices such as, the smartphones, tablets, etc., is almost non-existent. While the voice assistants are quite effective at handling generic voice requests such as, responding to weather queries, setting up alarms, opening apps, etc., they, at best, fare poorly with performing granular functions within apps, especially when it comes to third-party app. For example, one cannot have a voice assistant to “LIKE” a specific Instagram post while browsing Instagram feed. In another example, one cannot get the voice assistant to move a specific shopping item into the shopping cart.

### SUMMARY

An embodiment of the present disclosure is directed to a voice-based User Interface (UI) system for granular control of a smartphone's interactive content. The system comprises an adaptive focus zone, which comprises a rectangular area of smartphone display extending between the longitudinal edges of the screen. The focus zone is preferably disposed within the top half of the smartphone screen wherein, said location is where the user's eyes naturally land when looking at the smartphone display in portrait orientation. The system is configured such that, when a cluster comprising one or more user-selectable display items (such as, a link, app, etc.) are within (or brought to be within) the purview of the focus zone, inputting a voice command results in the selection of a selectable item of the one or more selectable items.

Other features and advantages will become apparent from the following description of the preferred embodiments, taken in conjunction with the accompanying drawings.

### BRIEF DESCRIPTION OF FIGURES

FIG. 1 is a block diagram of the voice-based UI system of the present disclosure.

FIG. 2 is an illustration of the smartphone depicting the focus zone within the display.

FIG. 3 is another illustration of the smartphone depicting the focus zone within the display.

FIG. 4 depicts focus zone segments within a focus zone on top of an exemplary shopping app.

FIGS. 5A & 6A depict the clusters in exemplary Twitter® and YouTube feeds respectively.

FIGS. 5B & 6B are exemplary individual clusters pertaining to Twitter® and YouTube® respectively.

FIG. 7 is an illustration of the focus zone containing apps located within an app drawer.

FIG. 8 is a screenshot of an app page with ad within the focus zone.

FIG. 9 is an illustration depicting clusters sandwiched between pairs of top and bottom cluster boundaries.

FIG. 10 comprises an illustration depicting the selection of a selectable item via an selection command.

FIG. 11 depicts exemplary sequential illustrations involved in preselecting focused items via a preselection command.

FIGS. 12A through 12B depict illustration of a smart TV capable of rotating between landscape and portrait orientations and vice versa.

FIG. 13 is a flowchart mapping the process involved in the selection of a focused item via a cluster command.

FIG. 14 is a flowchart mapping the process involved in the voice-selection of a focused item via one or more preselection voice commands.

FIG. 15 is a block diagram of an exemplary computer-implemented system.

### DETAILED DESCRIPTION

Embodiments of the present disclosure are explained in detail below with reference to the various figures. In the following description, numerous specific details are set forth to provide an understanding of the embodiments and examples. However, those of ordinary skill in the art will recognize a number of equivalent variations of the various features provided in the description. Furthermore, the embodiments and examples may be used together in various combinations.

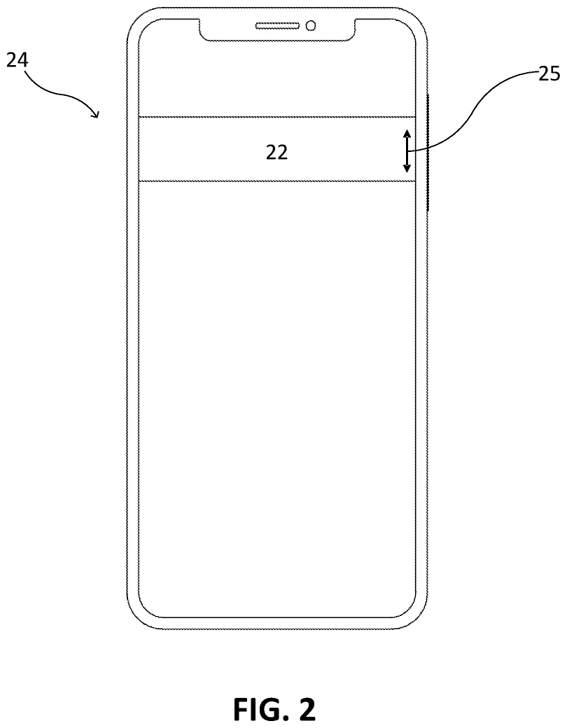

The following specification discloses embodiments of the present invention that are directed to a voice-based user interface system & method for operating a computing device via voice commands. The present disclosure also includes embodiments that are directed to the computing device itself (i.e., for instance, the smartphone shown in FIGS. 2, 3, 9 & 10) that is incorporated with the novel voice-based UI elements. The present disclosure also includes embodiments directed to an external device paired to the computing device wherein, both the external device and the computing device are incorporated with the novel voice UI elements. The computing device comprises a handheld smartphone, however, said system and method may also be adapted for other computing devices such as, tablets, phablets, foldable phones, smart TVs, etc., where the content that is displayed comprises portrait content, landscape content, content adapted for other form factors such as square content, etc. Notably, the computing device is also adapted to display content in various orientations including portrait and landscape. Notably, portrait content comprises content created in and adapted for “vertical” viewing experience defined by aspect ratios 9:16, 9:17, 9:19, 9:21, etc. The continuous vertical feed of information/content delivered by almost every smartphone app constitutes portrait content as well. On the other hand, landscape content comprises content created in and adapted for standard horizontal TV viewing experience defined by aspect ratios 16:9, 17:9, 19:9, 21:9, etc.

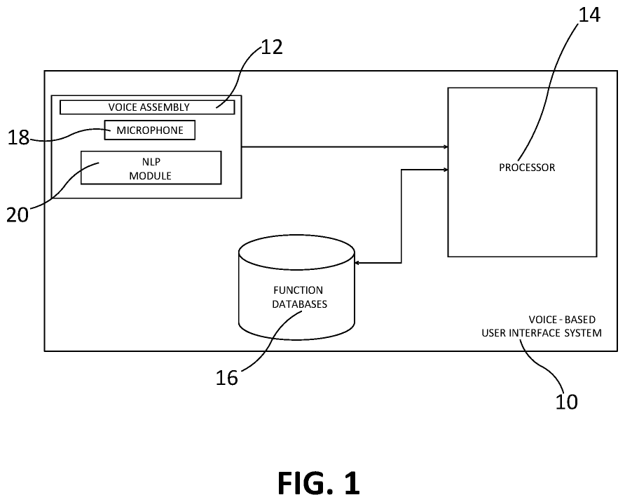

Referring to FIG. 1, the UI system 10 comprises a voice assembly 12 (hereinafter, the “voice assembly”) for receiving user voice-inputs and for processing said voice-inputs into voice commands that comprise cluster commands. Said voice commands are then relayed to a processor 14, which is part of the computing device. The processor 14, upon receiving the voice commands, performs corresponding, pre-assigned smartphone functions. In one embodiment, the processor 14 may be part of an external device that is disposed in operative communication with the computing device. The UI system 10 further comprises function databases 16 where, each voice command is pre-associated with a smartphone function. The function databases 16 are part of the operating system and each of the apps installed on the smartphone (i.e., the computing device). Once a voice command is received by the processor 14 via the voice assembly 12, a relevant function database 16 is parsed for a match. For example, if what is displayed on the screen pertains to the operating system (such as an app drawer), then the function database 16 that is parsed pertains to the OS. On the other hand, if what is displayed on the screen pertains to, say, a third-party app, then the function database 16 that is parsed pertains to said third-party app. A function database 16 can be accessed either remotely or natively. Upon match, the corresponding smartphone function is duly executed by the processor 14.

The voice commands comprise cluster and non-cluster commands. A non-cluster command is a common (or generic) command and inputting one results in the rendering of the same smartphone function across all smartphone screens and apps. Examples of non-cluster commands include “scroll up & down” voice command, a “go back” command, a “recent apps” command, a “go home” command, etc., that enable scrolling up & down the screen content, going back to the previous screen and taking the user to the home-screen respectively. A cluster command on the other hand is “context-specific” and only pertains to a part of the screen, which is referred to as the “focus zone” that is encompassing a “cluster.” Also, cluster commands can only work on apps that are “clustered.” The concept of “clusters” and “clusterized apps” would duly be explained in the following body of text.

Referring to FIG. 1, the voice assembly 12 comprises a microphone 18 onboard the smartphone for receiving user voice inputs. The voice assembly 12 further comprises a Natural Language Processing (NLP) module 20 disposed in operative communication with the microphone 18 for processing the voice inputs into voice commands that are executable by the computing device. In one embodiment, the NLP module 20 could be a part of the processor 14. In one embodiment, an Artificial Intelligence (AI) or a noise-cancellation module may be part of voice assembly 12 for filtering out ambient sounds other than the voice inputs. In one embodiment, said AI module is programmed to recognize user's voice and thereby distinguish user's voice and subsequently filter out nearby human voices that may potentially interfere with user voice input. In one embodiment, how the phone is held, which is determined by a gyroscope and an accelerometer, is also factored-in to ignore mis-commands. For example, the voice assembly 12 is configured to ignore voice inputs when the display of the phone is faced downwards as determined by the sensors. In one embodiment, the front camera would ascertain if the user is facing the screen when issuing voice inputs and if it is determined that the user is not looking at his/her phone, then the voice inputs are ignored. In one embodiment, the microphone 18 is programmed to detect how far the user is from the phone based on his/her decibel level and if it is determined that the user is too far from the phone, then his/her voice inputs are ignored by the voice assembly 12. In one embodiment, in the event of confusion, there'd be a visual or voice prompt to confirm a voice input. Notably, in the event of the computing device being a smartphone, tablet, or a phablet, the voice assembly 12 is part thereof.

Referring to FIG. 1, the system is configured such that, when a “clusterized” app is open, the voice assembly 12 is automatically activated right at the outset of said app launch. Notably, when the voice assembly 12 is activated for an app, it means that said app is sensitive to voice commands. Being automatically activated right at the outset eliminates the step of inputting an activation command (akin to saying “OK Google”, “Alexa”, etc.) or touch-inputting a commonplace microphone icon before inputting voice commands. In order for the automatic activation to commence, permission may have to be obtained from the user for said app to be enabled by the voice assembly 12. Once said app is closed, the voice assembly 12 for said app is deactivated as the function database 16 pertaining to said app is inaccessible. In one embodiment, a dedicated hardware button needs to be depressed before inputting the voice inputs. Depressing the hardware button acts as an indication of the user's permission for the voice assembly 12 to be activated for said app.

Referring to FIG. 1, the voice assembly 12 is disposed in operative communication with the smartphone display via the processor 14 such that, when the smartphone is displaying scrollable content thereon, inputting a “scroll up or down” voice command causes the scrollable content to be scrolled accordingly. In one embodiment, the UI system 10 is configured such that, when the user voice-inputs an exemplary “top” or “refresh” command, the display jumps to the top of the scrollable content thereby mimicking the “home” or “refresh” key on several feed-based apps like Twitter, Instagram®, YouTube, (Twitter®, Instagram®, YouTube®) etc.

Referring to FIG. 2, the UI system further comprises an adaptive focus zone 22 defined within the display of the smartphone 24. The focus zone 22 comprises a rectangular area extending between the opposing longitudinal edges of the portrait display/screen. More particularly, the vertical boundaries of the focus zone 22 comprise the vertical (longitudinal), physical boundaries of the screen or the smartphone display displaying content thereon such as, the app screen as the smartphone 24 is in portrait orientation. As the focus zone 22 is adaptive in nature, the distance between the horizontal boundaries is automatically (as indicated by the arrow 25) self-adjustable according to the content that is being displayed on the portrait screen. The utility of the adaptiveness of the focus zone 22 will be appreciated from the following body of text. In one embodiment, the focus zone 22 can also be defined in the landscape orientation of the smartphone 24 the same way it is defined within the portrait screen. Please note that the terms “display” and “screen” are sometimes used interchangeably and the difference between them is to be understood based on the context.

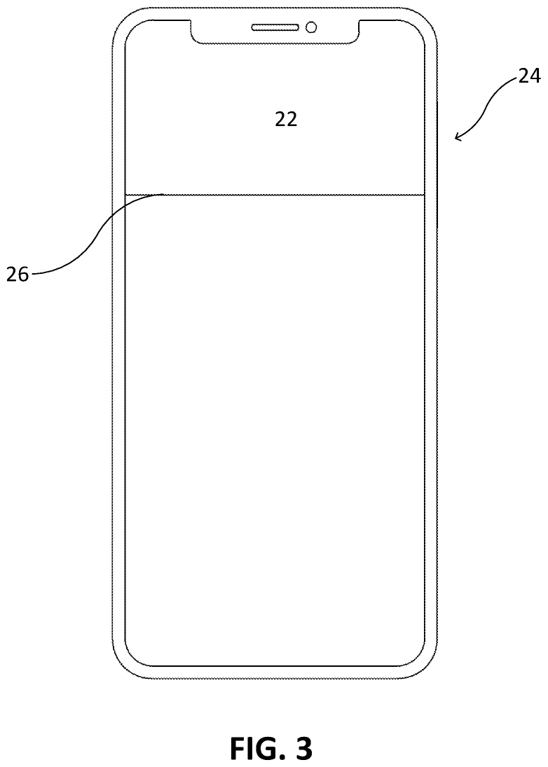

Referring to FIG. 2, the focus zone 22 is preferably disposed within the top half of the portrait screen. This is because, the top-half portion of the smartphone display is where the user's eyes naturally land when he/she looks at the smartphone display in portrait orientation. In one embodiment, as seen in FIG. 3, the focus zone 22 is defined to be an area located between a threshold marker 26 and top boundary of the screen itself.

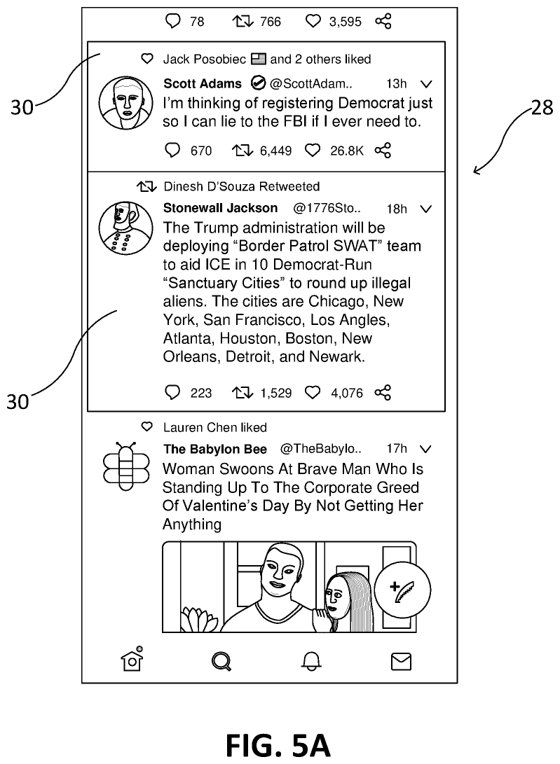

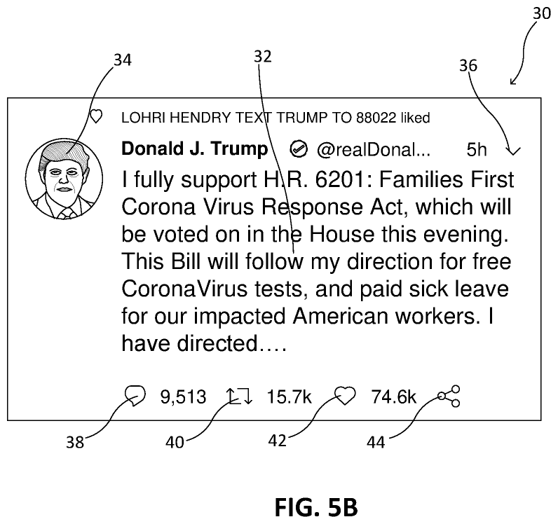

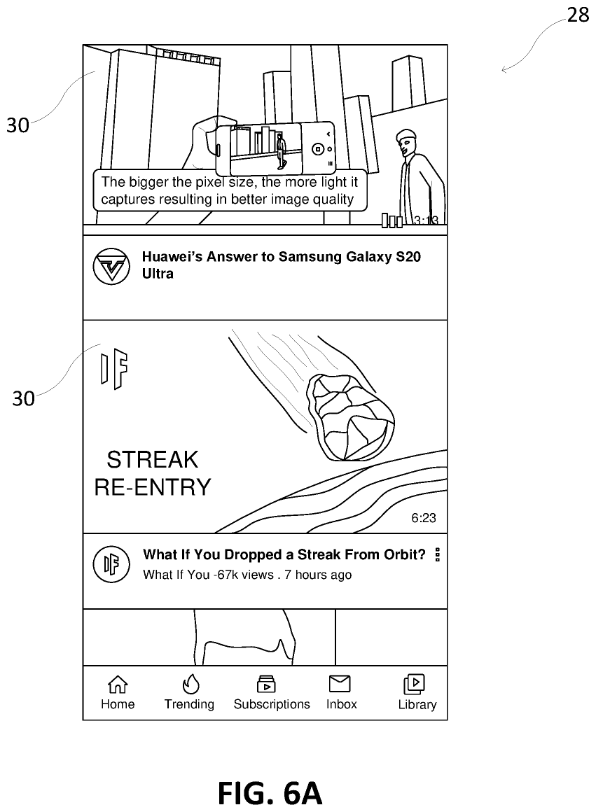

In feed-based and list-based, third-party apps like Twitter, Instagram, YouTube, etc., or proprietary apps (or screens) like the phonebook, app drawer, etc., the continuous vertical feed 28 of information therein is divided into a series of clusters 30 (ref. FIGS. 5A & 6A), wherein each cluster 30 comprises one or more user-selectable items such as, apps, hyperlinks (or links), a control within a notification panel, a key of a virtual keyboard, etc. For example, as seen in FIGS. 5A and 5B, each cluster 30 in Twitter generally comprises, a tweet-link 32, a profile link 34, an options link 36, a reply key (link) 38, a retweet key 40, a like key 42 and a share key 44. Notably, the options link 36 is further divided into several other sub-links that are tucked thereinto. Referring to FIGS. 6A and 6B, in YouTube, the feed information 28 is similarly divided into a series of clusters 30. Each such cluster 30 comprises the video link 46, channel link 48, and an options link 36, which further comprises other sub-links tucked thereinto. Therefore, basically, a cluster 30 is collection of related content that is grouped together wherein, said collection of content comprises one or more selectable items, i.e., links (32 to 48) in this case.

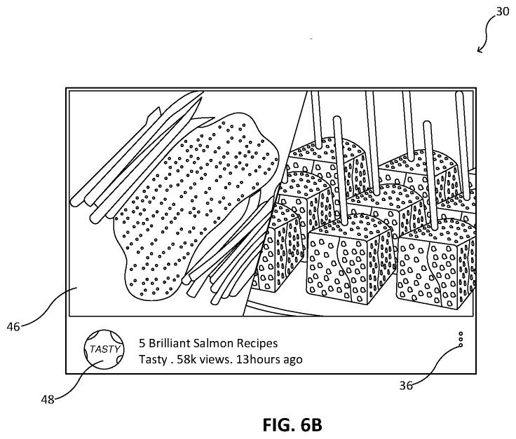

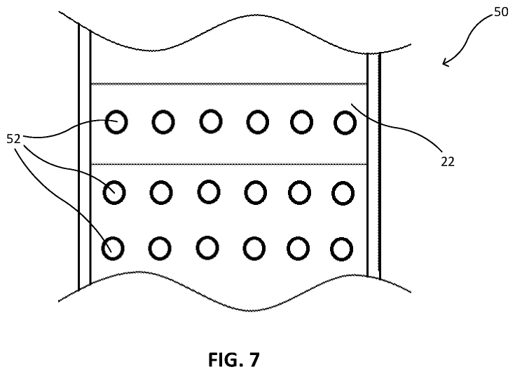

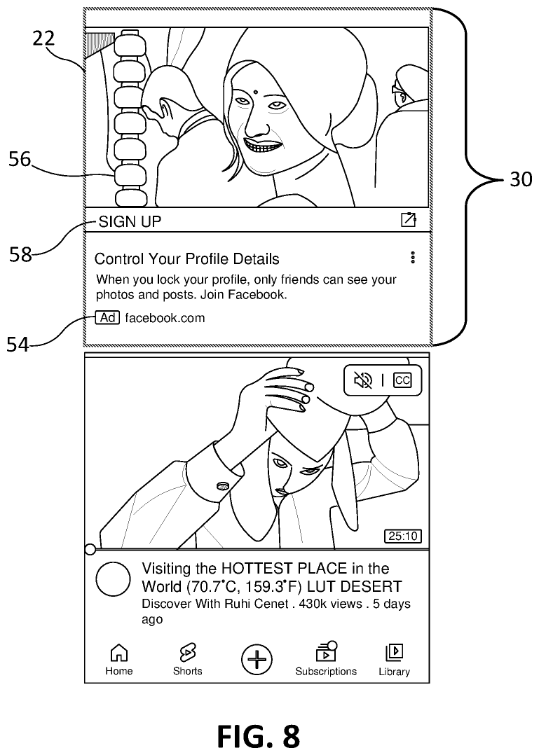

A cluster can also be a collection of unrelated content that is grouped together based on proximity. In an app drawer 50, a row of apps 52 that are within the focus zone 22, as shown in FIG. 7, is an example of this. Additionally, the collection of content may be grouped together based on both proximity and relevance as well. A cluster may comprise one or more sub-clusters. For example (not shown), the “Retweet” button within a Twitter cluster could be an example of a sub-cluster wherein, selecting the “Retweet” sub-cluster results in the display of additional selectable items comprising “Retweet”, “Quote Tweet” and “React with Fleet.” Notably, an app could have multiple types of clusters. For example, as can be appreciated from FIG. 8, an ad 54 comprising a picture 56 with selectable SIGN-UP button 58 (or BUY, SUBSCRIBE, LEARN MORE buttons, etc.), underneath it could be another type of cluster 30. Notably, when an app is “clusterized,” the clusters within said app can be “focused” at which point, the focused cluster is rendered sensitive to cluster commands. The selectable items within a focused cluster are referred to as the focused items. This will be duly explained in the following body of text.

Identifying clusters is a prerequisite for “focusing” clusters. There are multiple ways for the UI system to identify clusters on an app or screen whereby, as an identified cluster is received within the focus zone, said cluster is “focused” provided the cluster commands pertaining to said app (or cluster) are pre-associated with functions within the pertinent function database. This means that only the items (i.e., links, etc.) within the focused cluster are responsive to cluster commands inputted by the user. In other words, when a cluster command is inputted by the user, a corresponding focused item is simply selected. Notably, selection of the focused item may mean said item being actuated, launched, toggled/de-toggled, activated/deactivated, deployed, etc. For example, when Twitter is clusterized and when a Twitter cluster is focused, inputting “LIKE” and “RETWEET” cluster commands one after the other results in the “LIKE” and “RETWEET” buttons within said focused cluster to be selected respectively and accordingly. In other words, by inputting the “LIKE” and “RETWEET” cluster commands, the corresponding Tweet is ‘liked’ and ‘retweeted’ respectively. Visually, when a cluster is focused (i.e., brought within the focus zone by means of scrolling, etc.), the adaptive focus zone, by adjusting one or both of the horizontal boundaries thereof, encompasses the entirety of said cluster. At this point, said cluster may appear to be popped or framed. This enables the user to be cognizant of the cluster being focused, at which point, he/she may proceed to input cluster commands.

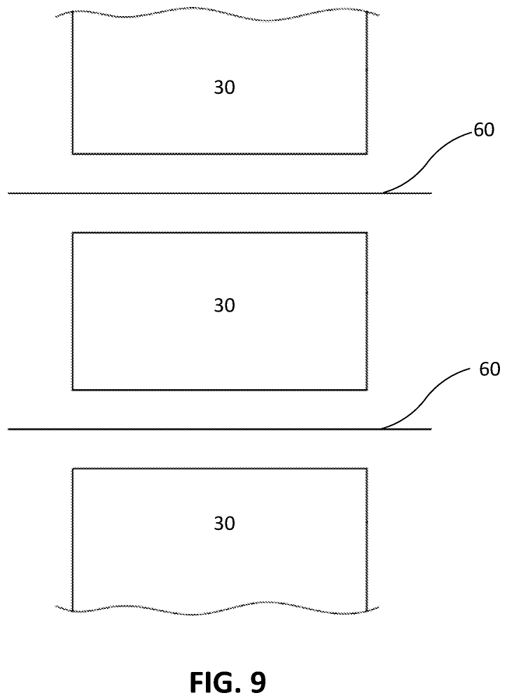

Referring to FIG. 9, each cluster 30 is sandwiched between a pair of top and bottom cluster boundaries 60 (i.e., lines), which are preferably provided by the corresponding app (or screen). Alternatively, a specific gap between two successive clusters may also act as a cluster boundary. Notably, in order for the third-party apps to be clusterized, said apps need to incorporate cluster boundaries within themselves. Therefore, one way of identifying a cluster is by identifying the cluster boundaries and whatever is located therebetween is in turn identified as a cluster. Upon identifying the cluster boundaries 60, the focus zone is configured to be, as mentioned earlier, regulated so as to fit or encompass (or “focus”) the entirety of the cluster therewithin. In one embodiment, the processor may harness computer vision technology such as, OpenCV®, etc., in order to recognize clusters. In another embodiment, Artificial Intelligence (AI) is employed so as to recognize clusters.

Another way of identifying a cluster is through backend cards. What is referred to as a cluster on the front-end comprises a card on the backend. A card, which basically is a template item, may also be referred to as a list item or a list tile. Unlike a cluster, a card may be readily identifiable without the need for boundaries or markers. Also, as the physical size (or area) of the card is same as that of the cluster it represents, when a cluster is received within the focus zone, the focus zone adjusts itself according to the corresponding backend card size and thus accommodates the entirety of the cluster within its purview.

In one embodiment, the system identifies a card based on the backend markers, such as, for example, HTML markers. These markers may already be placed before and after the cards at the backend or associated with a card. If not, then they may have to be incorporated into the backend by the corresponding app developers for the cards to be identifiable. Based on the marker(s), a card is identified, its size is determined and in turn, the cluster size is determined. Based on the determination of the cluster size, the focus zone is adapted to adjust itself in order to accommodate the entirety of the cluster as it is received therewithin. In one embodiment, a cluster is identified based on the combination of multiple elements including front end boundaries, cards and backend markers. Alternatively, some other means may also be employed for identifying clusters.

Referring to FIGS. 5A & 6A, the focus zone 22 is optimized to treat each cluster 30 as a single unit. Therefore, as content is scrolled and thereby is moved in and out of the focus zone 22, each cluster 30 is sequentially focused or, in other words, focused one at a time. This is despite the size variations between said clusters 30. For example, as can be appreciated from FIG. 5A, the size of the top cluster 30 is smaller than that of the bottom cluster 30. Irrespective of the size variations, the focus zone 22, which is adaptive in nature, is optimized to treat each cluster 30 as one unit and thereby encompasses the entirety of each cluster 30 as it is received within the focus zone 22. For instance, if the cluster 30 is smaller in size, the focus zone 22 shrinks itself to accommodate the entirety of the smaller cluster 30. Conversely, if the cluster 30 is larger in size, the focus zone 22 enlarges itself to accommodate the entirety of the larger cluster 30. Notably, as a threshold portion of the cluster 30 is received within the focus zone 22, the focus zone 22 moves to encompass the entirety of said cluster 30 within its purview. The threshold portion may be a predetermined physical area, a percentage area of the cluster, etc. In some cases, the focus zone 22 may encompass the entirety of the screen/display. This is applicable to content from TikTok, Instagram Reels, YouTube Shorts, etc. Therefore, the focus zone 22, in a way, is a mere representation of a “focused” cluster 30. This is visually all the truer in the event of the focus zone 22 being invisible.

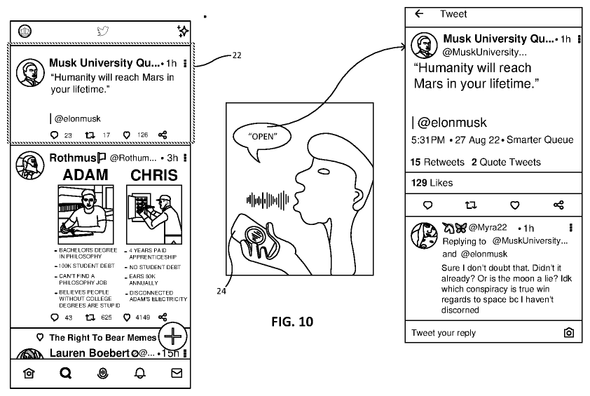

When a cluster is focused, inputting a cluster command results in the corresponding selectable item being selected. Each cluster command is pre-paired to a focused selectable item whereby, the number of cluster commands is equal to the number of focused selectable items (and the selectable items pertaining to sub-clusters thereof). When a cluster command is inputted by the user, the corresponding (or pre-paired) focused selectable item is selected. For example, referring to FIG. 10, when a Twitter cluster 30 is “focused,” inputting an exemplary “OPEN” or “YES” cluster command results in the tweet link being selected resulting in the expanded tweet being displayed on a different app page. This means that the “OPEN” (or “YES”) cluster command is pre-associated with tweet-link within the Twitter cluster.

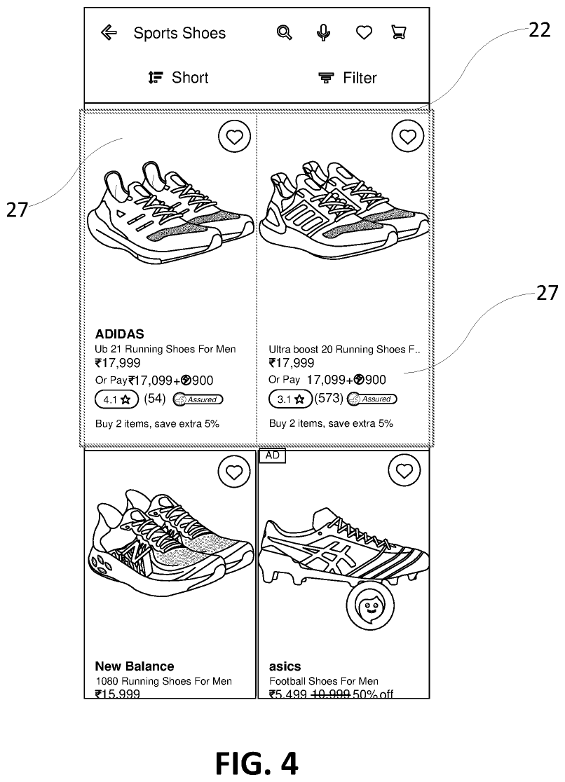

In some cases, a row of two or more clusters 27 may enter the focus zone 22. An example of this would be a shopping app where the shopping items are laid out in a grid layout as seen in FIG. 4. At this point, the focus zone 22 encompasses both the clusters 27 but however focuses one cluster 27 at a time. This means that only one cluster 27 is sensitive to cluster commands. At this point, inputting a cluster command results in the selection of a corresponding selectable item of the focused cluster 27. A user may input an exemplary “NEXT” or “SECOND” command, resulting in the second cluster 27 being focused at which point, said second cluster 27 becomes sensitive to cluster commands.

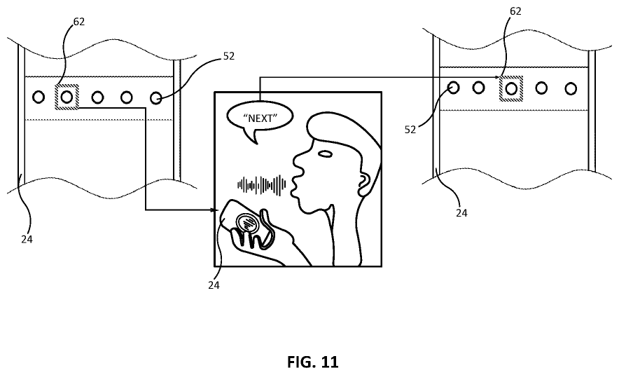

In one embodiment, the cluster commands comprise a preselection command wherein, inputting exemplary “NEXT” preselection commands results in sequentially preselecting the focused items. At a point where a desired focused item is preselected, inputting an exemplary “YES” or “OPEN” command results in the preselected item to be selected. The exemplary “YES” or “OPEN” command may be referred to as a selection command. For example, as can be appreciated from FIG. 11, when a row of apps within an app drawer is focused, inputting exemplary “NEXT” preselection commands results in the “focused” apps 52 being sequentially preselected. When a desired app 52 is preselected, inputting an exemplary “YES” or “OPEN” command results in the preselected item to be launched or opened. This way of navigation based on preselection of focused items can be applied to all cluster-types. In one embodiment, when an app is preselected, said app is visually popped or framed 62 for the user to take cognizance of the preselection thereof.

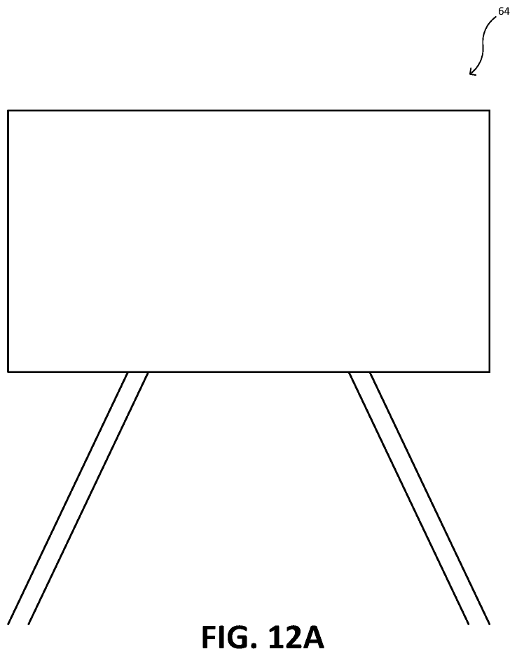

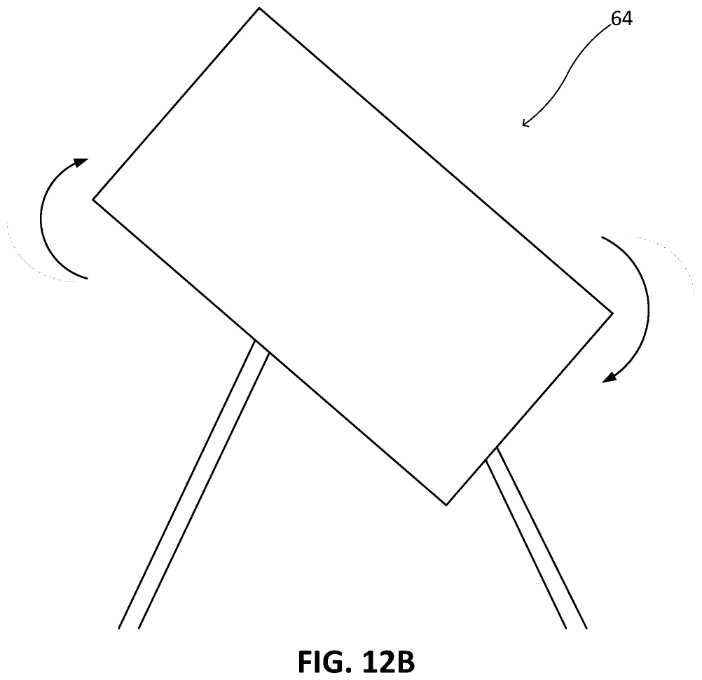

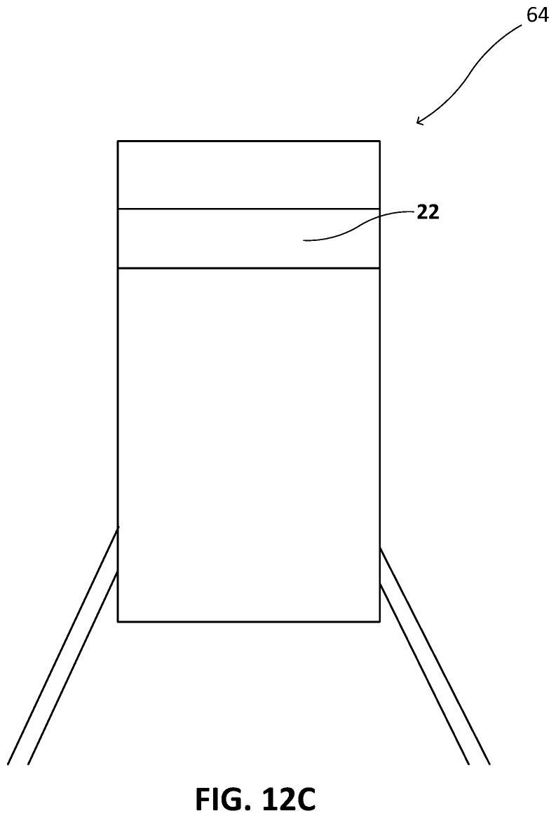

Referring to FIGS. 12A through 12C, in one embodiment, a smart TV 64 (i.e., a TV capable of installing apps) may be employed in place of a smartphone provided the smart TV 64 is in or can be rotated into portrait orientation (ref. FIG. 12C). However, the system also works on the typical landscape TVs as it's ultimately the display content (from apps like Twitter, Facebook, LinkedIn, TikTok, Instagram, etc.) that is rendered in portrait orientation even on landscape TVs. Said larger screen device may also be capable of being rotated between portrait and landscape orientations as seen in referred drawings. A case in point would be Samsung's Sero TV. As can be appreciated from FIG. 12C, within the display of said larger device is defined the focus zone 22 wherein, the focus zone 22 becomes functional when the screen of larger device is in portrait mode. The larger device is paired with the external device that houses the voice assembly 12 for receiving the voice inputs. The external device may comprise a TV remote controller, a game controller, a smart speaker (such as, Alexa Echo, Apple HomePod, or the like), a smartphone, or even a smartphone case paired to the smart TV that relays voice commands to said smart TV.

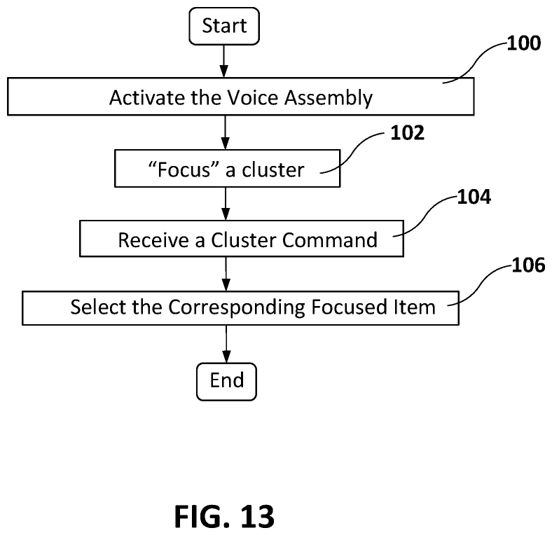

Referring to FIG. 13, in a method embodiment of the present invention initiates with activating (step 100) the voice assembly for processing cluster commands. The method further includes focusing (step 102) a cluster. In one embodiment, focusing a cluster may comprise focusing one of multiple clusters at a time that are within the focus zone. The method of focusing a cluster includes identifying said cluster in the first place and listing cluster commands within function databases wherein, each cluster command is pre-associated with a selectable item within a cluster. The method further includes the voice assembly receiving (step 104) a cluster command. The method finally includes selecting (step 106) a corresponding focused item.

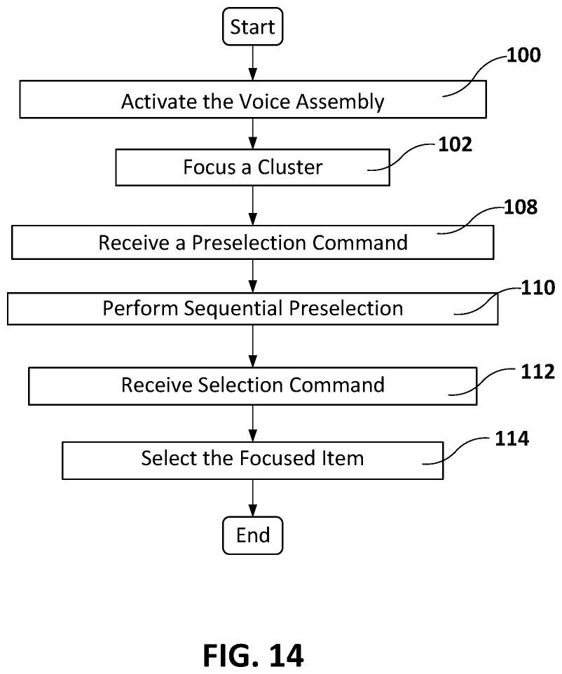

In another embodiment, referring to FIG. 14, upon activating the voice assembly (step 100) and focusing (step 102) a cluster, the method comprises receiving (step 108) a preselection command. Upon the reception of the preselection command, the method includes performing (step 110) a sequential preselection of a user-selectable item. The method further includes the voice assembly receiving (step 112) a selection command. The method finally includes selecting (step 114) the preselected item.

The device embodiment of the present disclosure comprises a smartphone 24 depicted in FIGS. 2, 3, 9 & 10 comprising the voice assembly 12 (FIG. 1) for receiving user voice inputs and processing said voice inputs into voice commands comprising cluster commands. The smartphone further comprises a processor 14 (FIG. 1) for receiving the voice commands transmitted by the voice assembly 12 and the adaptive focus zone 22 (FIGS. 2, 3, 4, 5A, 6A & 7) defined within the display thereof. When a cluster 30 (FIGS. 5A, 5B, 6A, 6B, 8, 9 & 10) is within the focus zone 22, the reception of a cluster command results in the selection of a corresponding selectable item. In another embodiment, the computing device comprises the smart TV 64 depicted in FIGS. 12A through 12C.

FIG. 15 is a block diagram of an exemplary computing device 116. The computing device 116 includes a processor 118 that executes software instructions or code stored on a non-transitory computer readable storage medium 120 to perform methods of the present disclosure. The instructions on the computer readable storage medium 120 are read and stored the instructions in storage 122 or in random access memory (RAM) 124. The storage 122 provides space for keeping static data where at least some instructions could be stored for later execution. The stored instructions may be further compiled to generate other representations of the instructions and dynamically stored in the RAM 124. The processor 118 reads instructions from the RAM 124 and performs actions as instructed. The processor 118 may execute instructions stored in RAM 124 to provide several features of the present disclosure. The processor 118 may contain multiple processing units, with each processing unit potentially being designed for a specific task. Alternatively, processor 118 may contain only a single general-purpose processing unit.

Referring to FIG. 15, the computer readable storage medium 120 any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 122. Volatile media includes dynamic memory, such as RAM 124. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Referring to FIG. 15, RAM 124 may receive instructions from secondary memory using communication path. RAM 124 is shown currently containing software instructions, such as those used in threads and stacks, constituting shared environment and/or user programs. Shared environment includes operating systems, device drivers, virtual machines, etc., which provide a (common) run time environment for execution of user programs.

Referring to FIG. 15, the computing device 116 further includes an output device 126 to provide at least some of the results of the execution as output including, but not limited to, visual information to users. The output device 126 can include a display on computing devices. For example, the display can be a mobile phone screen or a laptop screen. GUIs and/or text are presented as an output on the display screen. The computing device 116 further includes input device 128 to provide a user or another device with mechanisms for entering data and/or otherwise interact with the computing device 116. The input device may include, for example, a keyboard, a keypad, a mouse, or a touchscreen. The output device 126 and input device 128 are joined by one or more additional peripherals. Graphics controller generates display signals (e.g., in RGB format) to Output device 126 based on data/instructions received from CPU 710. Output device 126 contains a display screen to display the images defined by the display signals. Input device 128 may correspond to a keyboard and a pointing device (e.g., touch-pad, mouse) and may be used to provide inputs. Network communicator 130 provides connectivity to a network (e.g., using Internet Protocol), and may be used to communicate with other systems connected to the network.

Referring to FIG. 15, the data source interface 132 means for receiving data from the data source means. A driver issues instructions for accessing data stored in a data source 134, the data source 134 having a data source structure, the driver containing program instructions configured for use in connection with the data source 134.

Embodiments and examples are described above, and those skilled in the art will be able to make various modifications to the described embodiments and examples without departing from the scope of the embodiments and examples.

Although the processes illustrated and described herein include series of steps, it will be appreciated that the different embodiments of the present disclosure are not limited by the illustrated ordering of steps. Some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

I claim:

1. A voice-based user interface system 10 comprising:
(a) a voice assembly 12 for receiving user voice-inputs and processing said voice-inputs into voice commands comprising cluster commands;
(b) a computing device comprising a focus zone 22 defined within the display thereof, wherein when at least one cluster 30, each of which comprising one or more user-selectable items, is within the focus zone 22 whereby one of the at least one cluster 30 and thereby each of the one or more selectable items thereof are said to be focused, the reception of a cluster command by the computing device results in the selection of a corresponding focused item.

2. The system of claim 1, wherein the focus zone 22 is located within the top half of the display.

3. The system of claim 2, wherein the display comprises portrait display.

4. The system of claim 1, wherein the focus zone 22 extends between the two opposing edges of the display.

5. The system of claim 1, wherein the voice assembly 12 is part of the computing device.

6. The system of claim 1, wherein the voice assembly 12 is part of an external device paired with the computing device.

7. The system of claim 1, wherein the voice assembly 12 comprises a microphone 18 for receiving the voice-input from the user and a natural language processing module 20 for processing the voice-inputs into voice commands executable by the computing device.

8. The system of claim 1, wherein the computing device comprises a smartphone 24.

9. The system of claim 1, wherein each focused item is pre-paired with a cluster command whereby inputting a cluster command results in the selection of the corresponding focused item.

10. The system of claim 1, wherein the size of a cluster 30, which the focus zone 22 adapts to and thereby encompasses, is determined by the boundaries 60 said cluster 30 either on the frontend, backend, or both.

11. The system of claim 1, wherein the size of a cluster 30, which the focus zone 22 adapts to and thereby encompasses, is determined based on the size of the corresponding backend card.

12. The system of claim 1, wherein the size of a cluster 30, which the focus zone 22 adapts to and thereby encompasses, is determined based on the size of the backend card, which is identified by identifying a marker or markers associated therewith.

13. The system of claim 1, wherein a selectable item comprises one of an app icon, a hyperlink (or link), a control within notification panel, and a key of a virtual keyboard.

14. The system of claim 1, wherein the size of the focus zone 22 is adaptive so as to encompass varying cluster sizes.

15. The system of claim 14, wherein when a threshold portion of at least one cluster 30 is within the focus zone 22, the focus zone 22 at which point is adapted to encompass the entirety of said at least one cluster 30.

16. The system of claim 1, wherein the focus zone 22 is rectangular comprising top and bottom edges.

17. The system of claim 16, wherein the distance between the top and bottom edges vary so as to accommodate the entirety of a cluster 30 as said cluster is being received within the focus zone 22.

18. The system of claim 1, wherein a focused cluster 30 comprises a cluster 30 that is sensitive to cluster commands.

19. The system of claim 1, wherein in the event of the at least one cluster 30 comprising more than one cluster 30, said more than one cluster comprises a row of two or more clusters 30.

20. A computing device comprising:
(a) a voice assembly for receiving user voice-inputs and processing said voice inputs into voice commands comprising cluster commands;
(b) a processor 14 for receiving the voice commands transmitted by the voice assembly 12; and
(c) a focus zone 22 defined within a display thereof, wherein when at least one cluster 30, each of which comprising one or more user-selectable items, is within the focus zone 22 whereby one of the at least one cluster 30 and thereby each of the one or more selectable items thereof are said to be focused, the reception of a cluster command results in the selection of a corresponding focused item.

21. A voice-based user interface method comprising:
(a) when at least one cluster, each of which comprising one or more user-selectable items, is within a focus zone defined within the display of a computing device, whereby one of the at least one cluster and thereby each of the one or more selectable items thereof are said to be focused, receiving a user voice input via a voice assembly;
(b) processing the voice input into a voice command, which may comprise a cluster command, a cluster command comprising a voice command a cluster is sensitive to; and
(c) in the event of the voice command being a cluster command, in response to the reception of the cluster command, selecting a corresponding focused item.
